(19) United States
(12) Patent Application Publication
(10) Pub. No.: US 2007/0008236 A1
(43) Pub. Date: Jan. 11, 2007

(54) Compact dual-band antenna system

(75) Inventors: James K. Tillery, Woodstock, GA (US); James C. Carson, Sugar Hill, GA (US); Donald L. Runyon, Duluth, GA (US)

Correspondence Address: Michael L. Wach, Patent Agent;KING & SPALDING LLP, 34th Floor, 1180 Peachtree Street, N.E., Atlanta, GA, 30309-3521, US

(73) Assignee: EMS Technologies, Inc., Norcross, GA (US)

(21) Appl. No.: 11/481,490

(22) Filed: Jul. 6, 2006

Related U.S. Application Data
(60) Provisional application No. 60/696,856, filed on Jul. 6, 2005.

(51) Int. Cl. H01Q 21/26

(52) U.S. Cl. 343/797; 343/810

(57) ABSTRACT

A communication system can comprise an ordered arrangement or array of two sets, groups, or groups of antenna elements. The system can transmit or receive two bands or ranges of electromagnetic energy, signals, or radiation. The first set of the antenna elements can operate one of the bands, while the second set can operate the other band. The first set of antenna elements can be arranged or disposed to form a line or a column. The second set of antenna elements can be arranged or disposed on opposite sides of the line, with some of those elements on one side of the line and the remainder on the other side. The antenna elements that are on one side of the line can be staggered or longitudinally offset with respect to the antenna elements that are on the opposite side of the line.

### CROSS REFERENCE TO RELATED APPLICATIONS

This application claims priority to U.S. Provisional Patent Application Ser. No. 60/696,856, entitled “Compact Dual-Band Base-Station Antenna” and filed Jul. 6, 2005, the entire contents of which are hereby included herein by reference.

### FIELD OF THE INVENTION

The present invention relates to multi-element antenna systems and more specifically to a compact configuration for an antenna array of two groups of antenna elements, each group handling a different frequency band of electromagnetic radiation.

### BACKGROUND

Various types of antenna systems comprise arrays of antenna elements that receive or transmit electromagnetic radiation. For example, antenna arrays can be used to in space, airborne, or terrestrial applications, on mobile or stationary platforms, at fixed sites, in base stations, or on vehicles such as satellites and aircraft. In these and other applications, antenna designers often seek to achieve weight and/or size reduction without unduly sacrificing performance.

In a tower-mounted application for example, a compact lightweight antenna system may provide advantages in terms of wind loading, weight loading, installation cost and complexity, compliance with zoning restrictions, and aesthetic appeal. Moreover, compact antennas may achieve reductions in tower lease expenses, as a tower owner may calculate lease fees according to the area of the tower that each mounted antenna occupies.

One approach to addressing size and weight goals involves integrating two single-band antennas, each operating at a distinct band of frequencies, into a single unit. Thus, the integrated antenna unit supports operation at two frequency bands; each band typically carrying independent information. In this “dual-band” approach, the antenna unit typically contains an array of two groups of antenna elements, with one group serving the first frequency band and the other group serving the second frequency band.

The close proximity of the two groups of antenna elements operating a different frequency bands in conventional dual-band antenna arrays can result in undesired interaction. This undesired interaction can produce deleterious performance relative to a single band antenna array or interference between the two bands of operation. Thus, the two groups of antenna elements and the corresponding frequency bands can suffer from isolation issues, blockage issues, intermodulation issues, or generally a decreased signal quality as a result of having elements that radiate energy in one band near elements that radiate energy in the other band through coupling of energy among and between the two groups of antenna elements. Performance issues in dual-band antenna arrays can involve polarization quality, antenna gain, impedance matching and bandwidth, and pattern quality.

Antenna designers have attempted to arrange dual-band antenna arrays in a variety of configurations to achieve compact size while managing performance issues. However, many of the conventional technologies that are available for these configurations generally fail to provide a sufficient level of size reduction, band isolation, performance, and signal quality to meet the needs of current and expected applications for fixed and mobile communications.

Accordingly, to address these representative deficiencies in the art, what is needed is an improved capability for configuring multiple groups of antenna elements in a compact array that provides a high level of signal performance. Another need exists for an arrangement of an antenna array that processes two or more signal bands without unduly impairing “cross-band” isolation between those bands. Yet another need exists for improving the individual antenna elements of a dual-band antenna array so that each antenna element provides adequate performance without impeding the performances of adjacent antenna elements. Still another need exists for a technology that facilitates deploying and operating antenna arrays in a compact package or unit. A capability addressing one or more of these needs would help provide communication systems that use fewer or more compact antennas to transmit or receive electromagnetic energy.

### SUMMARY

The present invention supports receiving or transmitting signals in two or more frequency bands of electromagnetic signals via a compact antenna system in a single unit.

In one aspect of the present invention, the antenna can have bidirectional communications in two frequency bands. One of the bands can have a first frequency and/or a first wavelength, while the other band can have a second frequency and/or a second wavelength that characterize the band, such as a center frequency and/or a center wavelength. Thus, the antenna unit can process two or more distinct or different bands of frequencies or wavelength bands of electromagnetic energy. The bands might carry or convey different information, for example. The antenna can comprise an ordered arrangement, a configuration, or an array of two or more sets, types, or groups of antenna elements, for operation in the two or more bands of signals. The antenna elements can comprise dipole antennas, patch antennas, or some other devices that transmit electromagnetic, radiofrequency, or wireless signals. One set of the antenna elements can operate in one of the bands, while another set can operate the other band. In other words, a first set of antenna elements can transmit or receive a first range of frequencies, and a second set of antenna elements can transmit or receive a second range of frequencies. The first and second set of antenna elements can be arranged, disposed, or configured to provide a compact geometry by interleaving the sets of elements. The first set of antenna elements can be arranged or disposed to form a line or column of antenna elements. In other words, the first antenna elements can be situated in a one-dimensional array or in an essentially straight or linear formation. The second set of antenna elements can be arranged or disposed on opposite sides of the first set of antenna elements. In other words, the second set of antenna elements can be placed beside the line of first antenna elements, with some of those elements on one side of the line and the remainder on the other side. The antenna elements of the second set that are on one side of the line can be staggered with respect to the antenna elements of the second set that are on the opposite side of the line. Thus, each antenna element that is situated on one side of the line of first antenna elements can be longitudinally offset from each antenna element that is situated on the other side of the line. For example, the configuration can exhibit at least some degree of asymmetry with respect to the line.

The discussion of configuring antenna elements presented in this summary is for illustrative purposes only. Various aspects of the present invention may be more clearly understood and appreciated from a review of the following detailed description of the disclosed embodiments and by reference to the drawings and the claims that follow. Moreover, other aspects, systems, methods, features, advantages, and objects of the present invention will become apparent to one with skill in the art upon examination of the following drawings and detailed description. It is intended that all such aspects, systems, methods, features, advantages, and objects are to be included within this description, are to be within the scope of the present invention, and are to be protected by the accompanying claims.

### BRIEF DESCRIPTION OF THE DRAWINGS

FIGS. 1A, 1B, and 1C, collectively FIG. 1, are perspective, side, and overhead illustrations of an exemplary antenna system in accordance with an embodiment of the present invention.

FIG. 2 is an illustration of an exemplary configuration of an antenna system comprising high-band antenna elements and low-band antenna elements in accordance with an embodiment of the present invention.

FIGS. 3A, 3B, 3C, 3D, 3E, and 3F, collectively FIG. 3, are illustrations of exemplary configurations of antenna systems that comprise high-band and low-band antenna elements in accordance with embodiments of the present invention.

FIG. 4 is an illustration of a conductive layer, having a relatively large amount of surface area, of an exemplary low-band dipole antenna in accordance with an embodiment of the present invention.

FIG. 5 is an illustration of a conductive layer, having a relatively small amount of surface area, of an exemplary low-band dipole antenna in accordance with an embodiment of the present invention.

FIGS. 6A and 6B, collectively FIG. 6, are azimuth and elevation plots of low-band radiation patterns of an exemplary dual-band antenna system in accordance with an embodiment of the present invention.

FIGS. 7A and 7B, collectively FIG. 7, are azimuth and elevation plots of high-band radiation patterns of an exemplary dual-band antenna system in accordance with an embodiment of the present invention.

Many aspects of the invention can be better understood with reference to the above drawings. The components in the drawings are not necessarily to scale, emphasis instead being placed upon clearly illustrating the principles of exemplary embodiments of the present invention. Moreover, in the drawings, reference numerals designate like or corresponding, but not necessarily identical, elements throughout the several views.

### DETAILED DESCRIPTION OF EXEMPLARY EMBODIMENTS

The present invention supports configuring an ordered arrangement of at least two groups of antenna elements in a compact package without unduly sacrificing or compromising signal performance. The resulting antenna array system might provide wireless communication in a base station environment or in some other application that can benefit from compact equipment.

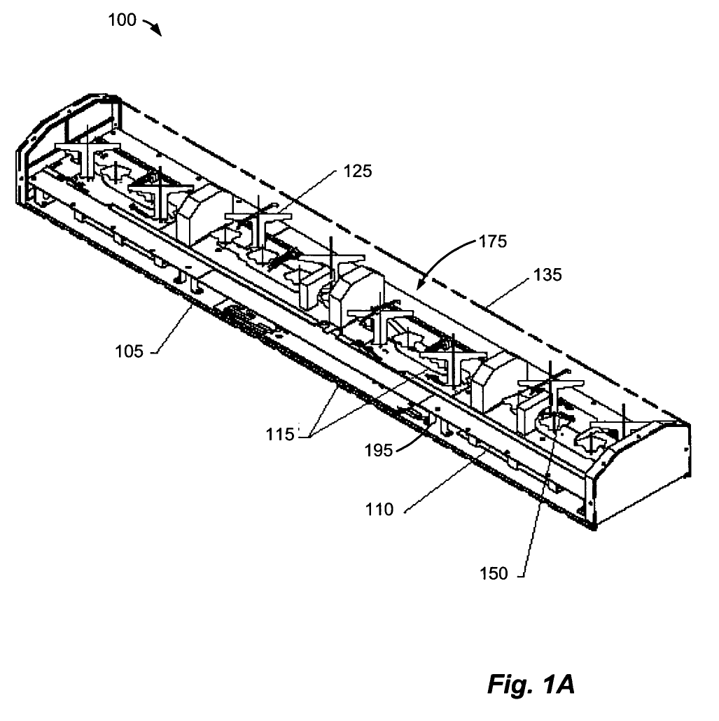

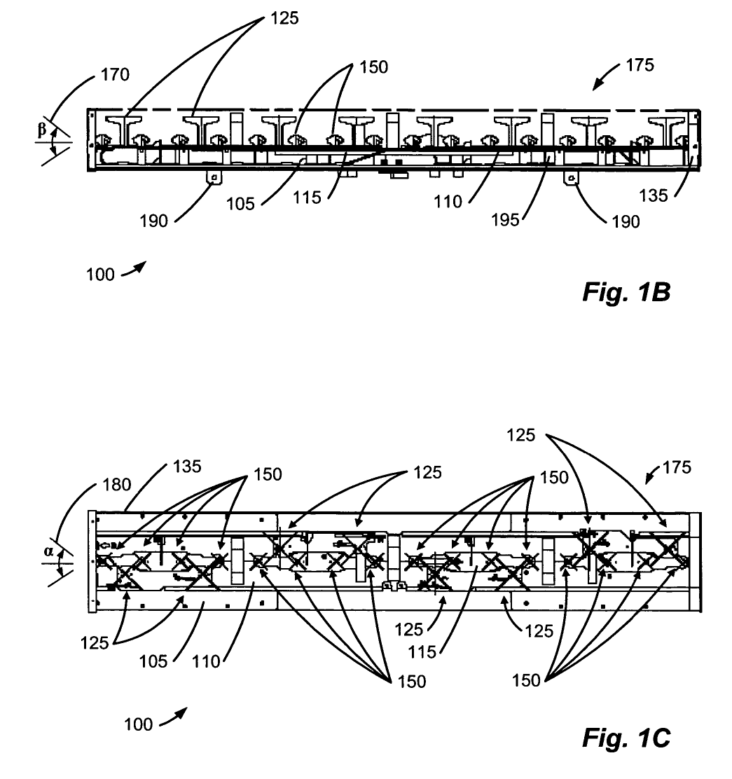

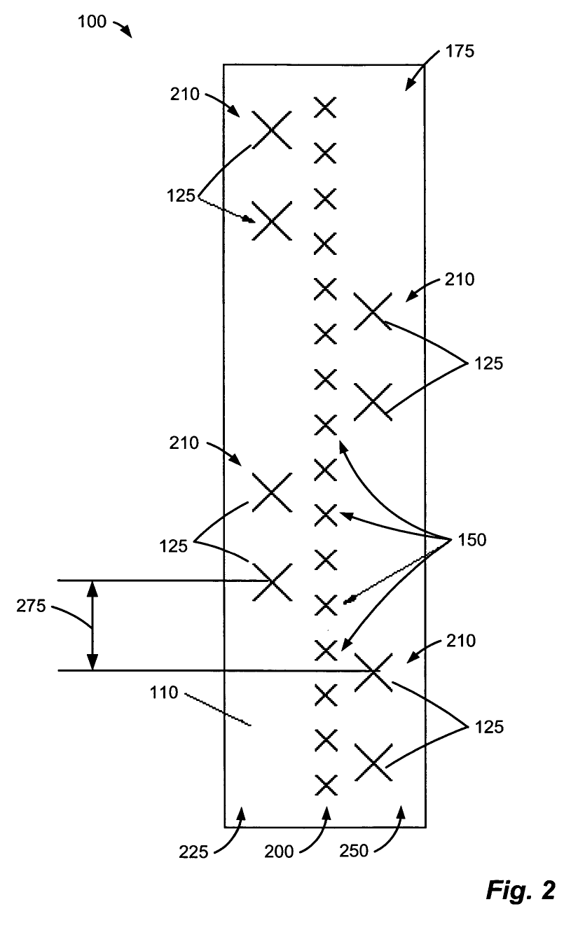

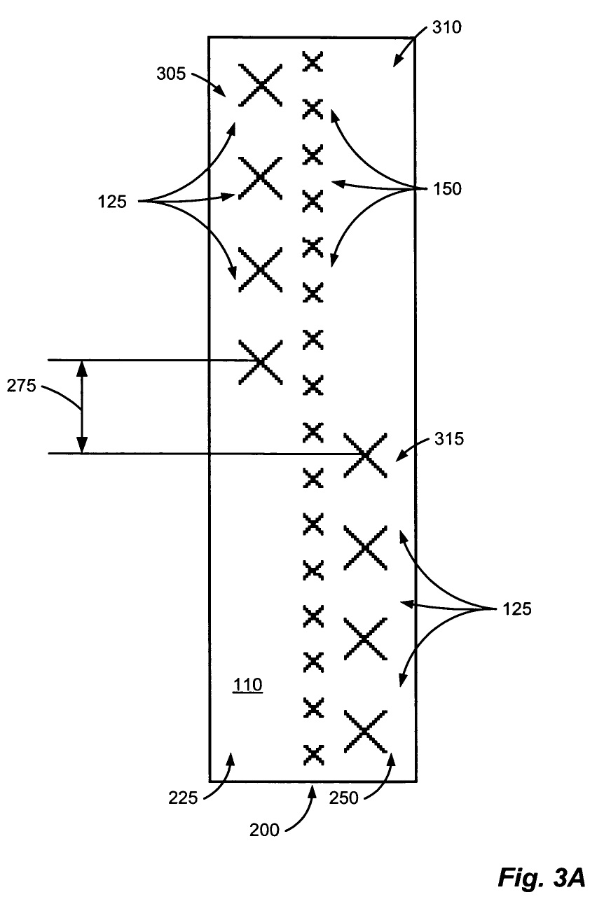

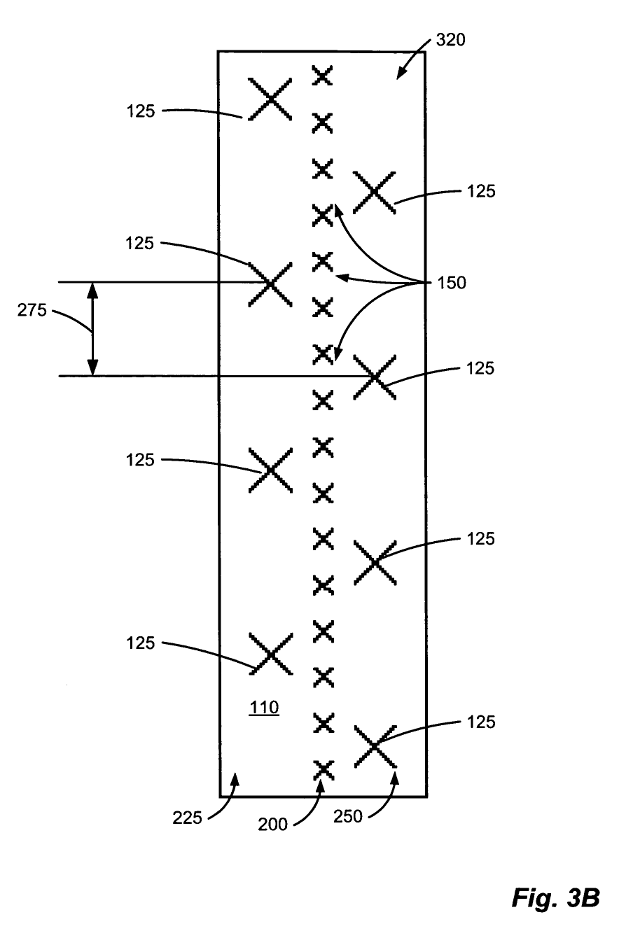

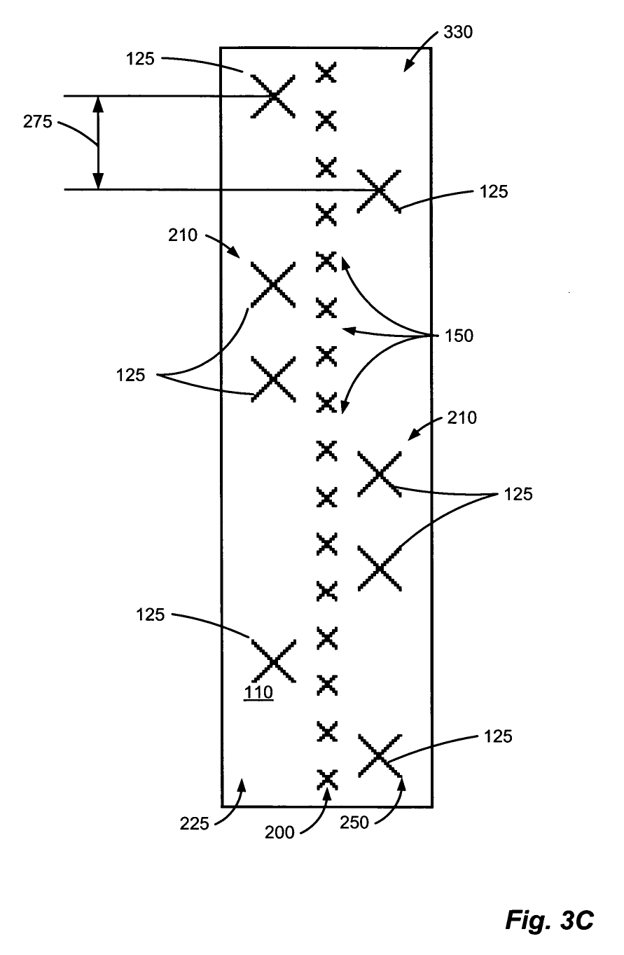

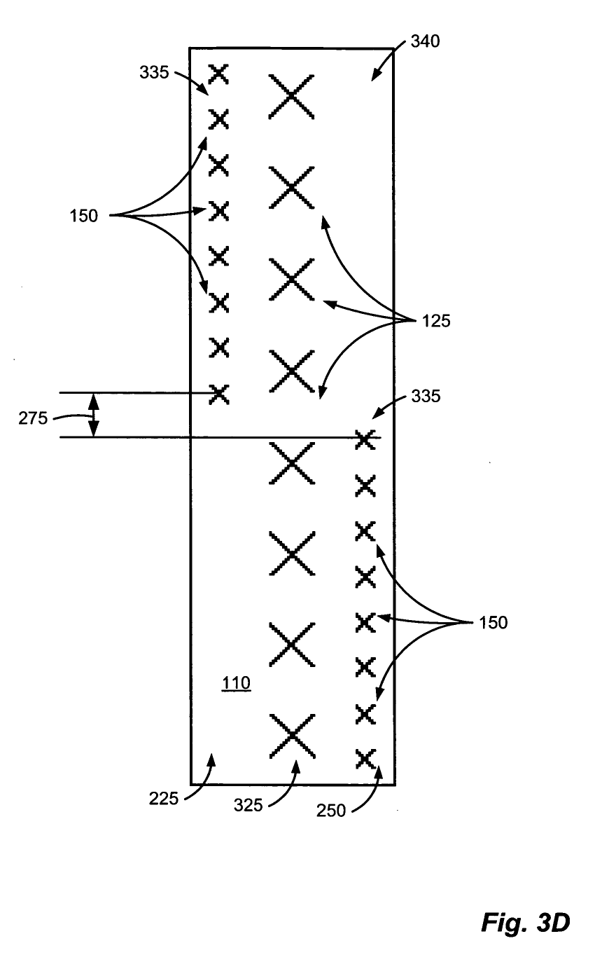

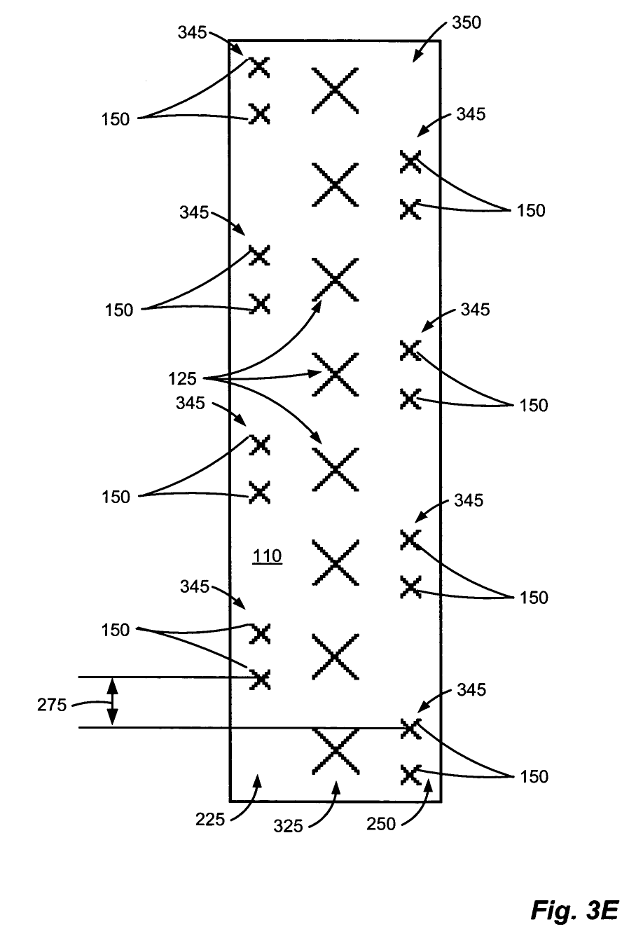

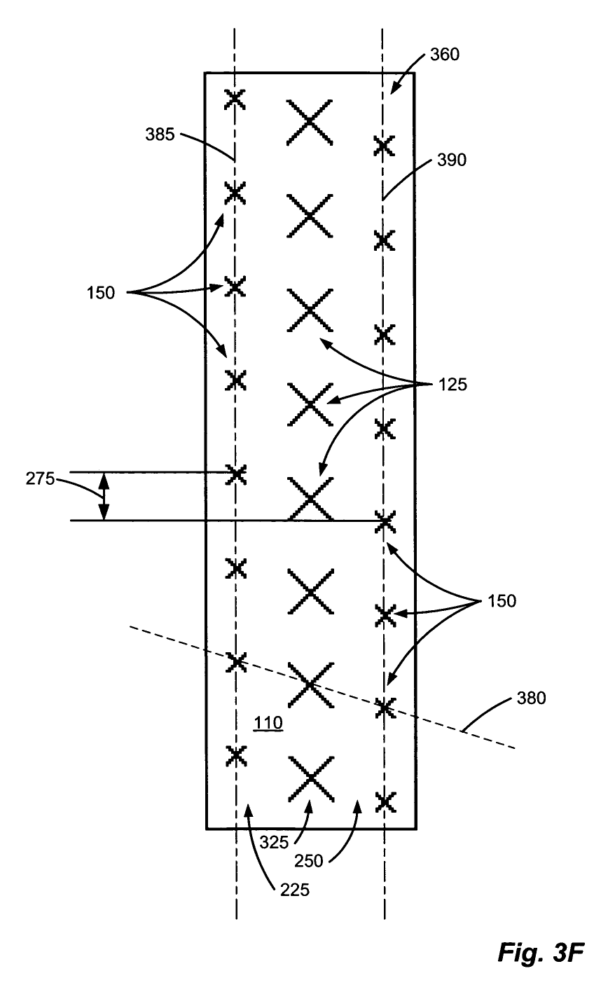

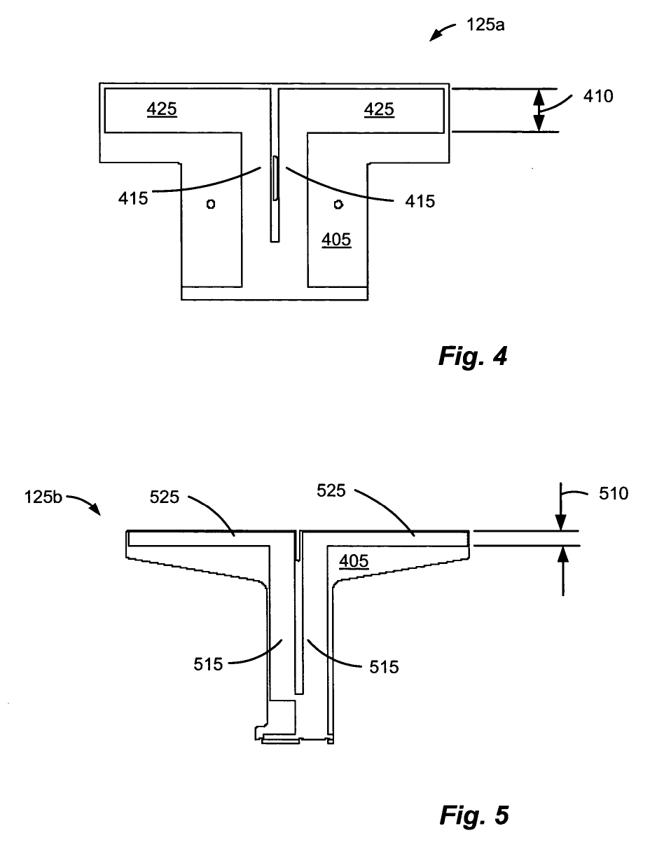

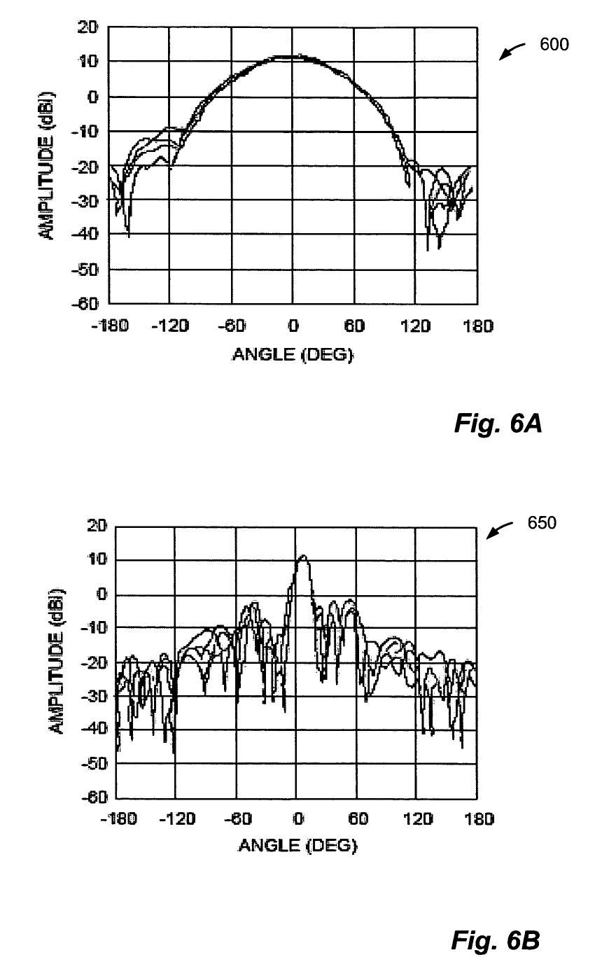

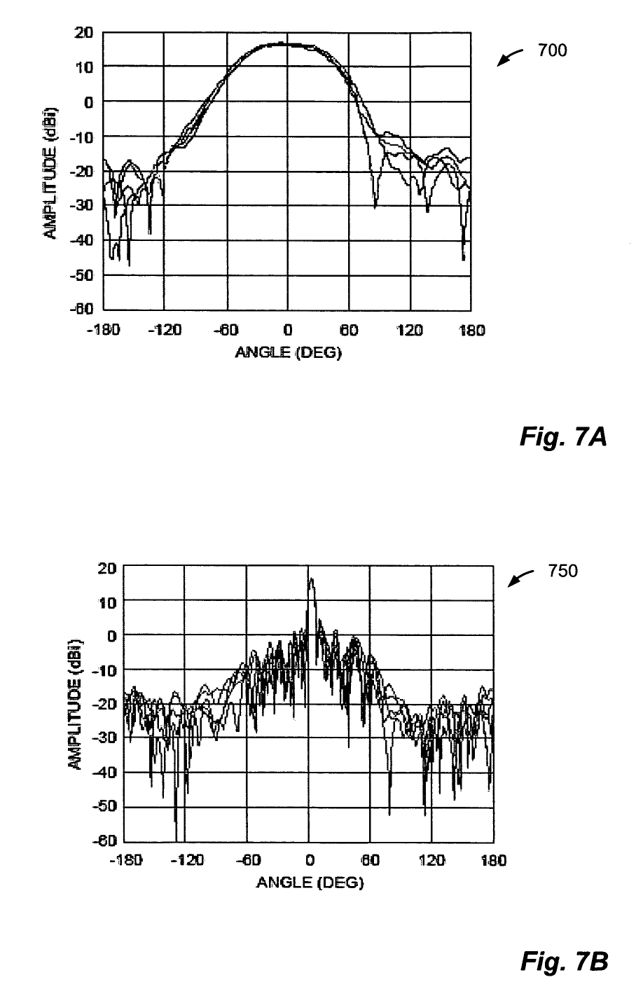

An antenna system comprising a compact array of antenna elements will now be described more fully hereinafter with reference to FIGS. 1-7, which show representative embodiments of the present invention. FIG. 1 provides a system view of a dual-band antenna. FIGS. 2 and 3 offer schematic views of various antenna array configurations. FIGS. 4 and 5 show detail views of antenna elements. FIGS. 6 and 7 present measured performance data.

The invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting, and among others supported by representations of the present invention.

Turning now to FIGS. 1A, 1B, and 1C, these figures respectively illustrate perspective, side, and overhead views of an antenna system 100 according to an exemplary embodiment of the present invention. The system 100 can operate as a component of a communication base transceiver station (“BTS”). For example, the system 100, or another system that incorporates technology of the system 100, may be used in one or more of the other applications or operating environments discussed herein.

Although the system 100 will be primarily discussed in the context of transmitting or radiating signals, exemplary embodiments of the present invention may receive, accept, or otherwise process various forms of electromagnetic energy or radiation. It is generally understood that the antenna is comprised of passive and ideally linear elements and the antenna performance and operation is reciprocal for transmit and receive and that bidirectional communication may occur even though the defined operation may be unidirectional.

The system 100 comprises an array 175 of two groups or kinds of antenna elements 125, 150, each serving a distinct range, span, or band of frequencies or wavelengths. The larger elements 125 operate and transmit a relatively low frequency band of signals. That low-frequency band can be referred to as a low-band. The smaller elements 150 operate and transmit a relatively low high band of signals. That high-frequency band can be referred to as a high-band. Thus, the array 175 comprises high-band antenna elements 150 and low-band antenna elements 125. Accordingly, the system 100 can be characterized as a dual-band antenna system.

As illustrated and in accordance with one exemplary embodiment of the present invention, the low-band antenna elements 125 operate a frequency band spanning between 806 and 896 megahertz (“MHz”) to support advanced mobile phone system/service (“AMPS”) and the special mobile radio (“SMR”) services. The low-frequency band can alternatively span from about 806 MHz to about 960 MHz. Meanwhile, the high-band antenna elements 150 operate the frequency band spanning between 1850 and 1990 MHz to support personal communication services/personal communications system (“PCS”). The high-frequency band can alternatively span from about 1710 MHz to about 2170 MHz. Thus in an exemplary embodiment, a gap or spacing may exist between the high-frequency band and the low-frequency band. In this exemplary embodiment, the ratio of the high-band to the low-band is a value of approximately two (2). It is further understood that a separation of operating frequency bands having a ratio of approximately two (2) establishes distinct and non-contiguous bands of frequencies.

In various exemplary embodiments, an ordered arrangement of radiating elements can transmit any of various signals or electromagnetic (“EM”) energy range. The low and high operating frequency bands are not limited within the electromagnetic spectrum.

As will be discussed in further detail below with reference to FIGS. 4 and 5, the antenna elements 125, 150 typically each comprises a dipole antenna. It is understood that the particular radiating element is not limited to a dipole antenna and that the antenna array 175 can comprise other types of antennas including but not limited to horns, patch antennas, notch radiators, Yagi-Uda antennas, helical/helix antennas, to name but a few examples.

In one exemplary embodiment, the high-band signals are polarized, and the low-band signals are polarized. Accordingly, an embodiment of the system 100 can be characterized as comprising a dual-band, dual-polarized base-station antenna. The bands might each have linearly polarized signals or circularly polarized signals, for example. It is understood that the high-band and the low-band radiating elements may have different polarization implementations.

As an alternative to being differentiated on the basis of size and/or frequency response, some other feature or attribute can differentiate the two groups of antenna elements 125, 150 from one another. For example, the antenna array 175 can comprise elements that operate distinct signal polarizations, amplitudes, coherencies, phases, beam widths, beam divergence angles, beam patterns, or that use distinct antenna technologies.

In one exemplary embodiment, every antenna element 125, 150 of the array 175 can be categorized, classified, or grouped into exactly one of two sets (or three or some other selected number of sets). For example, a portion of the total antenna elements 125, 150 of the array 175 can belong to or can be a member of a high-band group of antenna elements 150, while the remainder of the total antenna elements 125, 150 of the array 175 can belong to or can be a member of a low-band group of antenna elements 125. It is understood that at least a portion of a high-band group of antenna elements is in relatively close proximity to a low-band group of antenna elements.

In one exemplary embodiment, each antenna element in each such group is interchangeable or is essentially identical, for example being fabricated to a common manufacturing specification. Alternatively, each group can comprise antennas elements that have purposeful differences, for example being fabricated according to different manufacturing specifications. Further, each group can comprise antenna elements that have been modified slightly, trimmed, or adjusted to achieve an operational goal. For example, certain antenna elements of a group may be adjusted during assembly of the system 100 so that the system 100 meets a signal performance specification.

While the illustrated system 100 has two groups of antenna elements 125, 150 to operate two frequency bands, another exemplary embodiment has three groups of antenna elements to operate three distinct frequency bands. Thus, an antenna designer might base a tri-band antenna on one of the antenna configuration technologies discussed herein. As one example, a tri-band antenna may comprise bands for 806-896 MHz, 1850-1990 MHz, and 2500-2700 MHz operation in a single antenna unit. In an exemplary embodiment of the present invention, for any of the antennas, the ratio of the lowest frequency of a higher band to the highest frequency of a lower band is at least a value of 1.1 to define distinct and non-contiguous bands of operation. For example, the band pair of 1710-2170 MHz and 2500-2700 MHz has a ratio of 2500/2170 MHz that is approximately 1.15. Another exemplary embodiment may comprise an arbitrary number, such as four, five, six, etc., of groups of antenna elements to operate a corresponding arbitrary number of signal bands.

Referring now to FIG. 1, the antenna array 175 is disposed above two ground planes 105, 110, an upper ground plane 110 and a lower ground plane 105. The ground planes 105, 110 typically each comprises a conductive surface. Thus, each ground plane 105, 110 typically has an essentially uniform or common voltage across its planar surface. The ground planes 105, 110 can comprise metallic or conductive layers applied to boards or sheets of dielectric material, for example. In one exemplary embodiment, at least one of the ground planes 105, 110 comprises a thin sheet, plate, or member of metal, such as aluminum or copper. Mechanical members or supports 195 mechanically couple the upper and lower ground planes 105, 110 to one another, to provide rigidity or physical integrity, for example. The supports 195 may be electrically conducting and may be in direct contact with one or both ground planes 105, 110 and can provide an operational frequency or direct current (“DC”) path between ground planes 105, 110. The supports 195 may be in part or in whole made from an insulating material and provide DC isolation between ground planes 105, 110.

Remote electrical tilt (“RET”) circuitry and related electrical and mechanical components (not clearly detailed in FIG. 1) can be attached to the lower ground plane 105. The RET circuit allocates power to sub-arrays of the antenna array 175 to provide band-specific remote control of the geometry or direction of the transmit energy patterns from the system 100. The RET circuit comprises a variable power divider circuit (“VPD”), a Butler matrix circuit (a beam forming network) and a fixed power divider circuit. The VPD feeds the Butler matrix circuit, which in turn feeds the fixed power divider circuit.

The RET circuit can have a reduced size and a reduced complexity relative to conventional RET circuits. For example, a convention RET circuit may employ extended transmission lines between the VPD and the fixed power divider circuit and between the fixed power divider circuit and the Butler matrix circuit. Those conventional extended transmission lines typically function as transformers to match the otherwise-mismatched impedances of conventional VPDs, conventional static power dividers, and conventional Butler matrix circuits. In contrast to most conventional RET circuits, the system 100 can comprise a RET circuit that is based on impedance matched components to eliminate the need for impedance-matching transmission lines or impedance transformers. More specifically, the RET circuit of the system 100 typically comprises a VPD, a Butler matrix circuit, and a static power divider circuit that have compatible, matched input and output impedances. Basing an RET circuit on impedance matched components can eliminate the need for impedance-matching transformers or transmission lines. Moreover, incorporating impedance-matched components can facilitate direct connections between the VPD and the static divider and between the static power divider and the Butler matrix circuit.

Thus, one exemplary embodiment of the system 100 can comprise conventional RET circuits with impedance-matching transmission lines. And as a compact alternative to impedance-matching transmission lines, another embodiment of the system 100 may comprise an impedance-transforming quadrature hybrid inside a Butler matrix.

With the RET circuit mounted on the lower ground plane 105, an antenna feed network (not clearly detailed in FIG. 1) is mounted at the upper ground plane 110 on a printed circuit board (“PCB”) 115. Disposing the RET and feed network circuits on separate ground planes 105, 110 helps reduce the width of the system 100 relative to mounting those components on a single surface. The antenna elements 125, 150 are also mounted on the PCB 115.

PCB jumper cards provide the high-band antenna elements 150 with connectivity to the RET circuit and to the antenna feed circuits respectively mounted at the lower and upper ground planes 105, 110. Coaxial cable connects the low-band antenna elements 125 to the RET and antenna feed circuits. More generally, PCB jumper cards or coaxial transmission lines can be used for both or either frequency bands.

In one exemplary embodiment of the present invention, the coaxial cables are directly attached to the circuit boards, for example via a soldering process. The direct connection can eliminate the need for a physical “launch” component or a similar intermediate connector, thereby achieving a reduction in size, weight, complexity, and cost.

As shown in FIG. 1B, the low-band antenna elements 125 are typically mounted above the high-band antenna elements 150 with respect to the upper ground plane 115. In other words, the high-band antenna elements 150 and the low-band antenna elements 125 are disposed above the upper ground plane 115 so that the tallest portion of low-band antenna elements 125 is farther away from the ground 115 plane than is the tallest portion of the high-band antenna elements 150. Those skilled in the art will appreciate that the ground plane 115 can be considered a physical reference plane, with the antenna elements 125, 150 mounted above, whether the system 100 is mounted in an inverted, upside down, sideways, vertical, or other orientation on a cellular tower. As discussed in further detail below with reference to FIGS. 4 and 5, the low-band antenna elements 125 can comprise narrow radiating conductors that help avoid interference between the high-band and the low-band antenna elements 125, 150.

The system 100 also comprises a housing 135 that can be characterized as a protective cover, a radome, or an enclosure. Including the housing 135, the system 100 can have a length of approximately 72 inches or 183 centimeters, a width of approximately 12 inches or 30 centimeters, and a height of approximately 7 inches or 18 centimeters.

While providing environmental protection against rain and dirt, the housing 135 typically provides at least one area that is transparent (or at least largely transmissive) to the operating frequencies of the system 100 and specifically to the high-band and the low-band signals. A plastic, fiberglass, or composite sheath (not explicitly illustrated in FIG. 1) can attach to the portions of the housing 135 illustrated in FIG. 1. While FIG. 1 shows a portion of the housing 135 having an open area to clearly show the antenna array 175, those skilled in the art will appreciate that the system 100 can comprise a shell or some other structure that fully encloses or encases the antenna array 175. In other words, in one exemplary embodiment, the housing 135 comprises a component that covers the antenna array 175 and that allows the transmission of the electromagnetic radiation that the antenna array 175 transmits. Accordingly, the system 100 can be viewed as integrating two single-band antennas into a single package, thereby creating a dual-band antenna in a unitary housing 135 or enclosure.

The housing 135 also comprises one or more mounting brackets 190 that facilitate attaching the system 100 to a cellular tower, a roof, or an outer wall of a building, for example. With the advantage of compact size, the system 100 can be mounted at a site while conserving site “real estate” to facilitate mounting other antennas or electrical devices at the site. Accordingly, the compact attribute of the system 100 supports increasing the density of devices that can be deployed at a particular location. Moreover, the compact size can support elevating the volume of communication traffic that a site can cost-effectively handle.

Turning now to FIG. 2, this figure illustrates a configuration of an antenna system 100 comprising high-band antenna elements 150 and low-band antenna elements 125 according to an exemplary embodiment of the present invention. More specifically, FIG. 2 illustrates an overhead view of a representative layout or configuration of the antenna array 175 of the system 100 that FIG. 1 depicts. The dual-band array 175 is illustrated schematically with each high-band antenna element 150 represented as a relatively small “X” and each low-band antenna element 125 represented as a relatively larger “X.” The high-band elements 150 are configured as a single dimensional (“1-D”) array of elements. In other words, the high-band elements 150 comprise a linear antenna array as illustrated in FIG. 2. The low-band elements 125 are configured in a staggered arrangement to effectively form a two-dimensional (“2-D”) array of elements. In other words, the low-band elements 125 comprise a planar antenna array as illustrated in FIG. 2.

The high-band antenna elements 150 are positioned or disposed in, along, or at a line 200, thereby forming a linear formation, a line 200, or a column of high-band antenna elements 150. In one exemplary embodiment of the present invention, each and every high-band antenna element 150 of the array 175 is included in the line 200.

Those skilled in the art will appreciate that the line 200 can deviate or waver somewhat from straight, for example as a result of manufacturing tolerances, assembly error, etc. In one exemplary embodiment, the line 200 has a purposeful or an intended bend, curvature, waver, or contour (not illustrated in FIG. 2).

The low-band antenna elements 125 are positioned in a staggered arrangement with respect to the line 200. Some of the low-band antenna elements 125 are located on the left-hand side 225 of the line 200, while the remaining low-band antenna elements 125 are located on the right-hand side 250 of the line 200. In one exemplary embodiment of the present invention, each and every low-band antenna element 200 of the array 175 is located adjacent the line 200 in a staggered configuration. The left- and right-hand sides 225, 250 can be viewed as exemplary opposing or opposite sides of the line 200.

Each low-band antenna element 125 on the right-hand side 250 of the line 200 of high-band antenna elements 150 is longitudinally offset from each low-band antenna element 125 on the left-hand side 225 of the line 200 of high-band antenna element elements 150. Thus, along the length dimension of the line 200, a distance 275 separates the left-hand elements 125 from the right-hand elements 125. In other words, the direction of the longitudinal offset distance 275 is aligned with line 200.

In one exemplary embodiment, as illustrated in FIG. 3B, each and every low-band antenna element 125 is longitudinally offset from each and every high-band antenna element 150.

In the illustrated configuration in FIG. 2, which is exemplary, the low-band antenna elements 125 are spatially paired on each side of the line 200. The pairs 210 are staggered on opposing or opposite sides of the line 200. The spacing between each low-band antenna element in each pair 210 can be uniform or equal. Each antenna element pair 210 can be characterized as a sub-array or as an array subunit. As an alternative to pairing the low-band antenna elements 125, those elements 125 can be grouped or arranged in threes, fours, fives, sixes, sevens, etc. The antenna elements of such groups can be uniformly or equally spaced.

The ordered arrangement 175 of antenna elements 125, 150 can be viewed as asymmetric with respect to a centerline 200. That is, rather than providing an axis of bilateral symmetry, the line 200 can mark an axis of asymmetry.

The low-band antenna elements 125 can be configured in a zigzag or oscillating pattern adjacent the line of high-band antenna elements 150. That is, the pattern of the low-band antenna elements 125 can zigzag or oscillate across or over the column 200 of high-band antenna elements 150. The low-band antenna elements 125 can alternatively be viewed as interleaved or as disposed in a crisscross, meandering, or weaving pattern across the high-band antenna elements 150.

The antenna configuration of FIG. 2 can further be viewed as comprising three lines of antenna elements 125, 150. As such, the first line 200 of high-band antenna elements 150 is centered, or is equally spaced, between two lines of low-band antenna elements 125, one on the left-hand side 225 and one on the right-hand side 250.

The physical spacing between each of the low-band elements 125 can be specified according to the characteristic wavelength of the signals that those elements 125 operate. Similarly, the physical spacing between each of the high-band elements 150 can be specified according to the characteristic wavelength of the signals that those elements 150 operate. The characteristic wavelength can be defined as the wavelength corresponding to the center of the operating band.

For example, an exemplary spacing between adjacent low-band antenna elements 125 can be in a range of 0.5 to 0.85 times the center wavelength of the low-frequency band. An exemplary spacing between adjacent high-band antenna elements 150 can also be in a range of 0.5 to 0.85 times the center wavelength of the high-frequency band. In one exemplary embodiment, the spacing between the adjacent antenna elements 125, 150 of each band is about 0.7 times the length of one cycle of the band radiation in or along the direction of signal propagation.

Separating the respective antenna elements 125, 150 of the array 175 according to a wavelength specification can provide coherency or a phase relationship among those elements 125, 150 that helps the elements 125, 150 operate in a collaborative manner. Thus, the high-band antenna elements 150 can be arranged in a coherent or phased array. Likewise, the low-band antenna elements 125 can be arranged in a coherent or phased array.

As discussed in further detail below with reference to FIGS. 6 and 7, the antenna array configuration of FIG. 2 can provide a high level of band-to-band isolation and desirable radiation patterns in a compact format. Moreover, the antenna array 175 of the system 100 can comprise antenna elements 125, 150 that are arranged to provide a compact configuration without sacrificing signal performance.

Turning now to FIG. 3, this figure illustrates configurations 310, 320, 330, 340, 350, 360 of antenna systems that comprise high-band and low-band antenna elements 125, 150 according to various exemplary embodiments of the present invention. The illustrated configurations are provided to illustrate principles of exemplary embodiments of the present invention and are neither limiting nor exhaustive. One of ordinary skill in the art should be able to devise other antenna configurations based on those illustrated configurations, the other drawing figures, the accompanying text, and that ordinary skill, for example.

The exemplary array configuration 310 of FIG. 3A comprises a line 200 or linear formation of high-band antenna components 150 and two groups 305 of low-band antenna elements 125, one on each side of the linear formation 200. The group 305 on the left-hand side 225 of the line 200 is offset or staggered with respect to the group 305 on the right-hand side 250 of the line 200. As discussed above, the groups 305 can be considered sub-arrays or array subunits.

The exemplary array configuration 320 of FIG. 3B likewise comprises a line 200 or column of high-band antenna components 150 with low-band antenna elements 125 staggered about the line 200. In this example, the individual low-band antenna elements 125 on each side of the line 200 are spaced equidistance with respect to one another. The low-band elements 125 are configured in a staggered arrangement to effectively form a 2-D array of elements having a triangular lattice or spacing arrangement. In other words, the low-band elements 125 comprise a planar antenna array as illustrated in FIG. 3B with a triangular spacing.

FIG. 3C depicts an exemplary array configuration 330 with a mix of paired low-band antenna elements 210, 125 and individual low-band antenna elements 125 on opposite sides of a line 200 of high-band antenna elements 150. In the illustrated configuration, the separate and paired low-band antenna elements 125, 210 are staggered about or across the line 200.

As shown in FIG. 3D and in accordance with an exemplary embodiment of the present invention, a centerline of antenna elements 325 can be formed from low-band antenna elements 125 rather than high-band antenna elements 150. In the illustrated configuration example 340, the high-band antenna elements 150 are arranged into two groups 335 or sets. More specifically, half of the high-band antenna elements 150 are grouped together on the left-hand side 225 of the line 325, while the other half of the high-band antenna elements 150 are grouped together on the right-hand side 250. The group 335 on the left-hand side 225 is longitudinally offset or staggered from the group 335 on the right-hand side 250.

FIG. 3E illustrates another configuration example 350 in which the low-band antenna elements 125 are arranged in a line 325 with the high-band antenna elements 150 situated on opposite sides of the line 325. The high-band antenna elements 150 are disposed in pairs 345 that are staggered on the left-hand side 225 and the right-hand side 250 of the line 325.

Whereas placing the high-band antenna elements 150 at a line 200, as illustrated in FIG. 2, may provide the high-band with preferential signal performance relative to the low-band, placing the low-band antenna elements 125 at a line 325 may provide preferential low-band signal performance. Thus, if an antenna designer seeks to provide one band with a preferential level of signal performance, the designer might position the antenna elements associated with that preferential band at the line 325.

The exemplary embodiment of FIG. 3F has approximately one-half of the high-band antenna elements 150 located along a line 385 on the left-hand side 225 of the line 325 of low-band antenna elements 125. The remaining high-band antenna elements 150 are located along a line 390 on the right-hand side 250 of the line 325 of low-band antenna elements 125. As illustrated, the line 380 can be viewed as a centerline that is positioned midway between the line 385 and the line 390. Alternatively, the line 380 can be off-center or positioned closer to one of the lines 385, 390 than to the other line 385, 390. Further, the line 380 can be skewed relative to at least one of the lines 385, 390. In one exemplary embodiment, the line 385 is skewed, tilted, or angled relative to the line 390.

The spatial separations between the individual high-band antenna elements 150 of the left-hand line 385 are uniform in the illustrated embodiment example. Likewise, an equal distance separates each of the individual high-band antenna elements 150 of the right-hand line 390. The high-band antenna elements 150 on each side of the line 325 of low-band antenna elements 125 are staggered or are longitudinally offset relative to one another.

The exemplary configuration 360 of FIG. 3F also has another pattern feature in that the antenna elements 125, 150 are disposed in threes along eight parallel diagonal lines 380, one of which is labeled with the reference number “380.” More specifically two high-band and one low-band antenna elements 150, 125 are located along the line 380, which forms an obtuse angle with the lines 325, 385, 390. The high-band elements 150 are configured in a staggered arrangement to effectively form a 2-D array of elements having a triangular lattice or spacing arrangement. In other words, the high-band elements 150 comprise a planar antenna array as illustrated in FIG. 3F with a triangular spacing.

While the configuration 360 has the lines 385, 325, 390 essential parallel to one another, other exemplary embodiments of the present invention may comprise nonparallel configurations. That is, in some circumstances, an antenna designer may find utility in placing the low-band antenna elements 125 and the high-band antenna elements 150 along three or more lines that are angled with respect to one another.

Antenna designers may use commercially available antenna design software, software that simulates electromagnetic field patterns, or other design tools to assist in selecting and/or fine tuning an antenna configuration in accordance with an exemplary embodiment of the present invention. That is, those of ordinary skill in the art may use know computer-based design tools, the disclosure and teachings presented herein, and their ordinary skill to make and use various antenna systems according to exemplary embodiments of the present invention.

Turning now to FIG. 4, this figure illustrates a conductive layer 415, 425, having a relatively large amount of surface area, of a low-band dipole antenna 125 according to an exemplary embodiment of the present invention. As discussed in further detail below, FIG. 4 illustrates a portion of a representative one of the low-band antenna elements 125 of the system 100.

As illustrated in FIG. 1 and as detailed in FIG. 4, an exemplary embodiment of the dual-polarized low-band antennas 125 comprises two leafs 125a that are slotted and mated to create a X-pattern assembly. FIG. 4 illustrates one of those two antenna element leafs 125a. The leaf 125a is mated at its center with a second leaf (not illustrated in FIG. 4) at a right angle. When integrated with the system 100 as illustrated in FIG. 1, the leaf 125a (along with its perpendicular counterpart) is disposed perpendicular to the upper ground plane 110.

Each leaf 125a comprises a dielectric substrate 405, typically a PCB substrate, with a metallic layer 415, 425 applied thereon. The metallic layer 415, 425 is typically formed using common processes for applying conductive metal layers or circuit traces to PCBs.

The metallic layer 415, 425 is patterned into two inverted “L” shapes 415, 425, each conducting and radiating signals when the antenna element 125 is operating. Thus, the L-shaped conductor 415, 425 pair can be characterized as a conventional T-dipole.

Each inverted L-shaped conductor 415, 425 comprises a vertical section 415 that carries signals in a perpendicular direction relative to the upper ground plane 110. An upper or horizontal section 425 joins the vertical section 415 at an essentially perpendicular angle and receives signals from the vertical section 415. The upper section 425 propagates those signals essentially parallel to the upper ground plane 110 and radiates electromagnetic energy during operation of the low-band antenna element 125.

The upper section 425 has a width 410 that is perpendicular to the axis of signal propagation in the upper section 425 and that is perpendicular to the layer thickness. The width 410 of the upper section 425 can influence the impedance bandwidth of the lower-frequency band and the extent to which the low-band antenna elements 125 interfere with the high-band antenna elements 150.

A typical width 410 of the upper conductor section 425 for the exemplary embodiment shown in FIG. 4 is in a range of 18 to 20 millimeters for a cell band of 806-896 MHz. In one exemplary embodiment of the present invention, the width 410 is approximately one-nineteenth ( 1/19) of the center wavelength of the signal band that the low-band antenna element 125 operates. In one exemplary embodiment of the present invention, the width 410 is greater than one-nineteenth ( 1/19) of the center wavelength of the frequency band that radiates from the section 425.

Increasing the width 410 typically increases the range or bandwidth of signal frequencies that the low-band antenna elements 125 can effectively radiate. That is, widening the section 425 or increasing the surface area of the section 425 typically provides a more uniform or more desirable antenna impedance response across the low-frequency band or reduces unwanted signal “roll-off.”

However, an increased width 410 can block or interfere with the radiation that emanates from the adjacent high-band antenna elements 150. As discussed above, the high-band antenna elements 150 are located beside and somewhat below the taller low-band elements 125. That is, the high-band antenna elements 150 are closer to the upper ground plane 110 than are the low-band antenna elements 125. Thus, the section 410 may tend to obscure, to scatter, or to inadvertently receive a portion of the electromagnetic signals that radiate from the high-band antenna elements 125.

One technique for mitigating the undesirable interaction between the section 410 of the low-band antenna elements 125 and the high-band antenna elements 150 is to increase the vertical separation between the high- and low-band antenna elements 125, 150. However, this approach can increase the size of the system 100 or may degrade the antenna array performance in one or both of the operational bands.

FIG. 5 depicts another approach to addressing unwanted interaction between the high- and low-band antenna elements 150, 125. More specifically, FIG. 5 illustrates a conductive layer 515, 525, having a relatively small amount of surface area, of a low-band dipole antenna 125 according to an exemplary embodiment of the present invention. The exemplary conductive layer layout 515, 525 of this leaf embodiment 125b has been configured to balance intra-band and inter-band performance as may be useful for certain applications.

In comparison to the exemplary embodiment of FIG. 4, the leaf 125b is configured to provide acceptable antenna frequency response while avoiding excessive interaction between the high- and low-band antenna elements 125. More specifically, the conductor width 510 is reduced by about 66 percent relative to the conductor width 410 of the leaf 125a, discussed above. Laboratory tests have unexpectedly shown that the width 410 can be reduced without sacrificing the bandwidth of the low-band antenna elements 125 to an unacceptable level. Thus, the width 510 can be adjusted to avoid blocking the signals that emanate from the high-band antenna elements 150 while maintaining acceptable signal performance of the low-frequency band.

A typical width 510 of the upper conductor section 525 for the exemplary embodiment shown in FIG. 5 is in a range of 6 to 8 millimeters for a cell band of 806-896-2170 MHz. In one exemplary embodiment of the present invention, the width 510 is approximately one-fifty-sixth ( 1/56) of the center wavelength of the signal band that the low-band antenna element 125 operates. In one exemplary embodiment of the present invention, the width 510 is less than one-fifty-sixth ( 1/56) of the center wavelength of the frequency band that radiates from the section 525.

Data collected in laboratory testing of an exemplary dual-band antenna system, similar to the system 100 illustrated in FIG. 1 and discussed above, will now be discussed with reference to FIGS. 6 and 7. FIGS. 6A and 6B respectively illustrate azimuth and elevation plane plots 600, 650 of low-band radiation patterns of a dual-band antenna system 100 according to an exemplary embodiment of the present invention. Meanwhile, FIGS. 7A and 7B, respectively illustrate azimuth and elevation plane plots 700, 750 of high-band radiation patterns of a dual-band antenna system 100 according to an exemplary embodiment of the present invention.

Each plot 600, 650, 700, 750 presents signal strength on a logarithmic scale (on the vertical, “Y,” axis) such that each grid crossing represents a ten-fold change in signal strength. The plots 600, 650, 700, 750 show those signal strengths as a function of angle measured in units of degrees (on the horizontal, “X,” axis).

The plots 600, 650 of FIG. 6 graphically present laboratory measurements of an exemplary beam pattern that the low-band antenna elements 125 collectively transmitted. The plot 600 describes the amplitude or signal strength of the low-band beam (or radiating energy pattern) in the azimuth dimension 180, which is the angle α (alpha) designated by the reference number “180” in FIG. 1C. In one exemplary embodiment, the azimuth dimension 180 can characterize the angular deviation or divergence of the transmitted beam parallel to the upper ground plane 110, with respect to the line 200 of high-band antenna elements 150.

The plot 650 describes the amplitude or signal strength of the low-band beam in the elevation or height dimension 170, which is the angle β (beta) designated by the reference number “170” in FIG. 1B. In one exemplary embodiment, the elevation dimension 170 can characterize the angular deviation or divergence of the transmitted beam perpendicular to the upper ground plane 110, with respect to the line 200 of high-band antenna elements 150.

The plot 700 of FIG. 7A describes a high-frequency beam (of the high-band) collectively transmitted by the high-band antenna elements 150 of the antenna array 175. Specifically, the plot 700 presents laboratory testing data of the intensity of a high-band beam in the azimuth dimension 180, angle α (alpha). Meanwhile the plot 750 of FIG. 7B presents the tests results of characterizing the transmitted high-band beam in the elevation dimension 170, angle β (beta).

As shown in the plots 600, 650 of FIG. 6, the system 100 can produce a low-band beam with desirable shape and directivity characteristics. And, the system 100 can provide a high-band beam that also exhibits desirable shape and directivity characteristics. Moreover, a dual-band antenna 100 having a staggered antenna array configuration 175 can achieve good signal performance in a compact package.

From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the exemplary embodiments, equivalents of the elements shown therein will suggest themselves to those skilled in the art, and ways of constructing other embodiments of the present invention will suggest themselves to practitioners of the art. Therefore, the scope of the present invention is to be limited only by the claims that follow.

What is claimed is:

1. An antenna system comprising an array of first, second, and third antenna elements, wherein:
the first antenna elements are operative to transmit a first range of frequencies and are disposed in a line,
the second and third antenna elements are operative to transmit a second range of frequencies, separated from the first range,
the second antenna elements are disposed at first respective longitudinal positions adjacent the line on a first side of the line, and
the third antenna elements are disposed at second respective longitudinal positions adjacent the line on a second side of the line.

2. The antenna system of claim 1, wherein each antenna element of the array that is operative to transmit the first range of frequencies is disposed in the line.

3. The antenna system of claim 1, wherein each antenna element of the array that is operative to transmit the second range of frequencies is a second antenna element or a third antenna element.

4. The antenna system of claim 1, wherein at least three antenna elements in the array are first antenna elements.

5. The antenna system of claim 1, wherein at least three antenna elements of the array are second antenna elements, and wherein at least three other antenna elements of the array are third antenna elements.

6. The antenna system of claim 1, wherein the second antenna elements and the third antenna elements are staggered about the line with respect to one another.

7. The antenna system of claim 1, further comprising an enclosure that houses the array and a ground plane below the array,
wherein the first range of frequencies comprises a center frequency,
wherein a center wavelength corresponds to the center frequency, and
wherein each antenna element of the second and third antenna elements comprises a metal layer conductor, the metal layer conductor comprising:
a first section for transmitting the second range of frequencies generally perpendicular to the ground plane; and
a second section, connected to the first section, for transmitting the second range of frequencies along a path generally parallel to the ground plane, wherein the second section has a dimension that is generally perpendicular to the generally parallel path, and wherein the dimension is less than one-fiftieth of the center wavelength.

8. The antenna system of claim 7, wherein at least one of the first antenna elements comprises a radiating conductor that is spaced from the ground plane less distance than the generally parallel path is spaced from the ground plane.

9. The antenna system of claim 1, wherein the second range of frequencies is lower than the first range.

10. A communication system comprising an arrangement of at least a first group of antenna elements for transmitting a first frequency band and a second group of antenna elements for transmitting a second frequency band, separated from the first frequency band,
wherein each antenna element in the first group of antenna elements is disposed above a conductive surface to form a line of the first group of antenna elements, and
wherein the second group of antenna elements are disposed in a staggered configuration adjacent the line and above the conductive surface.

11. The communication system of claim 10, wherein the staggered configuration comprises antenna elements of the second group disposed in offset longitudinal positions on opposing sides of the line.

12. The communication system of claim 10, wherein the first group of antenna elements and the second group of antenna elements each comprises at least three antenna elements.

13. The communication system of claim 10, wherein the communication system comprises:
at least three antenna elements of the first group; and
an enclosure for housing the arrangement.

14. The communication system of claim 10, wherein the staggered configuration comprises a first plurality of the second group of antenna elements disposed on one side of the line and a second plurality of the second group of antenna elements disposed on another side of the line in longitudinally offset positions with respect to the first plurality of the second group of antenna elements.

15. The communication system of claim 10, wherein the staggered configuration comprises pairs of the second group of antenna elements disposed adjacent the line.

16. The communication system of claim 10, wherein:
the second frequency band comprises a center frequency having a corresponding wavelength;
each antenna element in the second group of antenna elements comprises a flat conductor having a section that extends generally parallel to the conductive surface; and
the section has a width that is less than one-fiftieth of the wavelength.

17. An antenna system, comprising:
a housing;
a ground plane within the housing; and
an array of a first set and a second set of antenna elements adjacent the ground plane and within the housing, the first set for radiating a first band of electromagnetic energy, the second set for radiating a second band of electromagnetic energy,
wherein:
a range of frequencies separates the first band from the second band;
each antenna element of the first set is disposed adjacent the ground plane to form a column;
the second set of antenna elements essentially consists of a first plurality of antenna elements and a second plurality of antenna elements;
the first plurality of antenna elements is disposed adjacent the ground plane on a first side of the column;
the second plurality of antenna elements is disposed adjacent the ground plane on a second side of the column; and
each antenna element of the first plurality of antenna elements is longitudinally offset along the column from each antenna element of the second plurality of antenna elements.

18. The antenna system of claim 17, wherein each of the first plurality of antenna elements, the second plurality of antenna elements, and the first set of antenna elements comprises at least three antenna elements, and
wherein the first band of electromagnetic energy has higher frequency than the second band of electromagnetic energy.

19. The antenna system of claim 17, wherein each of the first plurality of antenna elements, the second plurality of antenna elements, and the first set of antenna elements comprises at least three antenna elements, and wherein the first band of electromagnetic energy has lower frequency than the second band of electromagnetic energy.

20. The antenna system of claim 17,
wherein the first band comprises a center frequency;
wherein a center wavelength corresponds to the center frequency;
wherein each of the first antenna elements comprises a metal layer conductor, the metal layer conductor comprising:
a first section for transmitting the first band of frequencies generally perpendicular to the ground plane; and
a second section, connected to the first section, for transmitting the first band of frequencies along a path generally parallel to the ground plane, wherein the second section has a dimension that is generally perpendicular to the path, and wherein the dimension is less than one-fiftieth of the center wavelength.

21. The antenna system of claim 17,
wherein the second band comprises a center frequency;
wherein a center wavelength corresponds to the center frequency;
wherein each of the second antenna elements comprises a metal layer conductor, the metal layer conductor comprising:
a first section for transmitting the second band of frequencies generally perpendicular to the ground plane; and
a second section, connected to the first section, for transmitting the second band of frequencies along a path generally parallel to the ground plane, wherein the second section has a dimension that is generally perpendicular to the path, and wherein the dimension is less than one-fiftieth of the center wavelength.
